(19) United States
(12) Patent Application Publication
(10) Pub. No.: US 2014/0297655 A1
(43) Pub. Date: Oct. 2, 2014

(54) Content Presentation Based on Social Recommendations

(71) Applicant: Google Inc., Mountain View, CA (US)

(72) Inventors: Marco Paglia, San Francisco, CA (US); Eunkyoung Song, Palo Alto, CA (US); Nathan Stuart Streu, San Francisco, CA (US); Donald Geoffrey Schuller, San Jose, CA (US); Satoe Haile, San Francisco, CA (US); Michael Siliski, San Francisco, CA (US); Ficus Kirkpatrick, San Francisco, CA (US); Aurash Mahbod, San Jose, CA (US); Paul Nicholas Gennai, San Francisco, CA (US); Ankit Jain, Milpitas, CA (US)

(21) Appl. No.: 13/854,184

(22) Filed: Apr. 1, 2013

(51) Int. Cl. H04L 29/08

(52) U.S. Cl. CPC H04L 67/22
USPC 707/748; 709/204

(57) ABSTRACT

The disclosed subject matter presents a method of using social connections to provide a content region definition that priorities the display of content on a user device based on information obtained from the social connections of the user.

### BACKGROUND

Digital media content, such as video, audio and textual content, may be obtained from a variety of sources. With the massive amount of digital media content available, a variety of methods of filtering through the digital media content to provide relevant content to a user typically are provided. For example, digital media content sources may provide filters and search mechanisms that allow a user to identify specific content or types of content in which he is interested. Other filtering mechanisms identify content that is believed to be of interest to a user, such as content created by the same author as content the user has previously viewed or purchased, or individual content items that are part of a larger corpus such as episodes of a television series, movie sequels, or the like.

### BRIEF SUMMARY

According to an implementation of the disclosed subject matter, a digital media content server may identify a user presence. The server may obtain an indication of content available for delivery, and may access a social connection of the user to determine a content recommendation provided by the social connection. Based upon the content recommendation provided by the social content, a presentation recommendation score may be generated. In response to the presentation recommendation score, a content region definition specific to the content available for delivery may be generated. The content region definition may include a presentation value.

The described method and system may provide more relevant content to the user based on the user's social recommendations. As a result, the user is presented with content that the user is more likely to enjoy and subsequently purchase, which is a benefit to the content provider. Furthermore, users are able to interact with their social network connections in yet another manner that strengthens the social connections between users.

Additional features, advantages, and implementations of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows a flowchart of a process according to an implementation of the disclosed subject matter.

FIG. 2A shows a graphic related to the content presentation according to an implementation of the disclosed subject matter.

FIG. 2B shows another graphic related to the content presentation according to an implementation of the disclosed subject matter.

FIG. 3 shows a computer according to an implementation of the disclosed subject matter.

FIG. 4 shows a network configuration according to an implementation of the disclosed subject matter.

### DETAILED DESCRIPTION

The amount of content available for consumption by users from websites may be staggering, and may intimidate some users. However, present filtering methods are often easily confused by, for instance, one time deviations from a user's typical content consumption patterns and may not sufficiently narrow the amount of content appropriately. In addition, the filters do not account for all of the environmental factors that may influence which content a user may want to consume. It would be advantageous if a reasonable amount of the content could be filtered to present more relevant content to the user.

In social networks, users may interact with groups of users based on some interest, such as friendship, common interest (e.g., book club, fan club, business clubs, hobbies, school, or work), trusted sources of content, such as particular magazines, news sources and the like, or other interactive groups. The social network users may generate reviews or recommendations of content. The reviews may be posted, for example, to the social network group associated with the reviewing user, or some other internet forum. Similarly, a user may recommend content to other users associated with the recommending user through the group associations. The disclosed subject matter may leverage the user's social network connections by incorporating recommendations by the user's social network into the determination of which content may be presented to the user. For example, a primary user may log into a website that provides content, and be presented with a webpage providing options for different categories of content. Categories of content may be, for example, music, books, videos, magazines, apps and the like. Specific content may include website content, such as blogs, computer applications, content reviews, video feeds, live audio or live video, user web queries, audio, video, digital magazines, digital books, gaming content and the like. The specific content may be arranged into content collections that are based on a respective content category. Upon selection of a category, a variety of content from the selected category may be presented to the primary user as a collection. The content in the content collection may be determined based on information from or related to the user's social connections and other factors.

The social connection may be with a trusted source of content, such as a digital magazine, digital book, blog sites, electronic newspaper or news program, computer application reviews, reference website, a commentator, or the like. Alternatively, the social connection may be an individual, such as a friend or favorite commentator, or a group of individuals, for example, a cycling club, a user group, or knitting circle. The content recommendations from either the trusted source or individual may be an indicator of the trusted source's, group's or individual's satisfaction, impression, feelings, value or the like with the content, such as a star ranking or a thumb's up icon. For example, if the primary user has a history with a content provider via a website, the variety of content in the content collection may be biased by content that the user previously purchased, sampled or reviewed while interacting with the content provider. Other factors may include a user's query history relative to the content, a user's content sampling history, a user's navigation within a website and other user activities. In other words, the content selected for delivery to the user device or server may be based on recommendations from the user's social connections, the user's history within the on-line store and other factors. The content described herein may include links or pointers to the underlying actual digital content. For example, when content is presented to a user, it may be presented in the form of an image, description, link, or the like, which is selectable by the user and links to the underlying content or to a location from which the user may view or purchase the underlying content. As a specific example, when a video is to be presented to a user as disclosed herein, it may be presented in the form of a content card or similar interface. The interface may include an image, text, and/or a playable video which, when selected by the user, allows the user to navigate to a website or other entity from which the user may view and/or purchase the complete video.

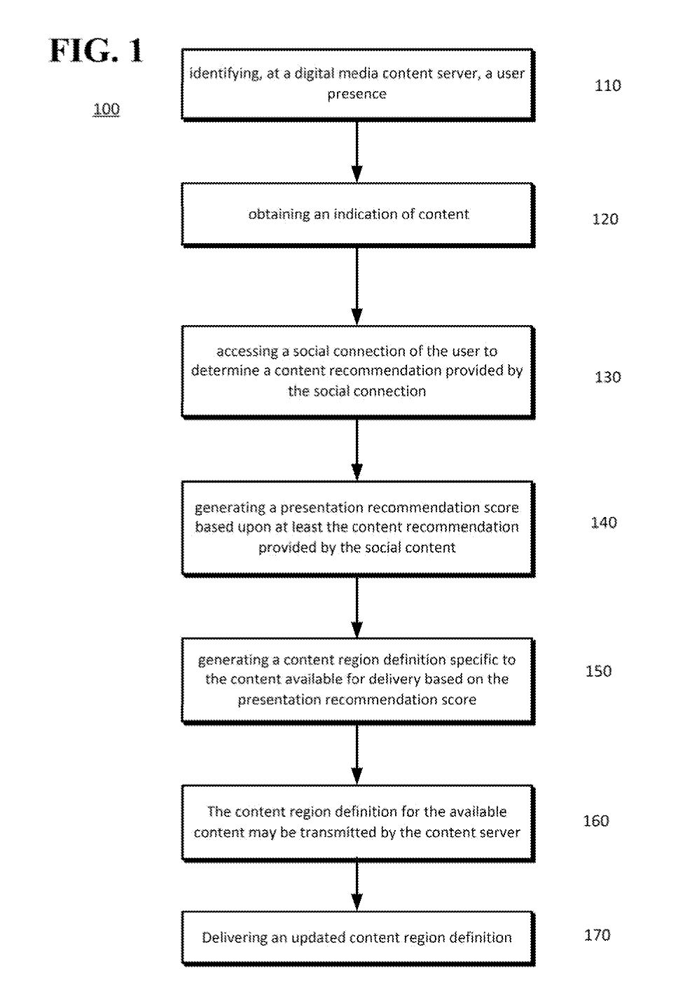

FIG. 1 shows a flowchart of a process according to an implementation of the disclosed subject matter. The method 100 may include identifying, at a digital media content server, a user presence (110). In addition, the server may obtain user preference data and user history. The user's preference data and user history may be received from a portable device associated with the user, a different server, or may be stored in a data storage associated with the digital media content server. The user preference data and the user history may be stored at various locations and may be obtained from various sources. The user history may relate to a user's interaction with a content provider. For example, a user's history with an on-line content store may relate to the user's purchases of content. The user history may change over time because it may be adaptively based on various actions, such as a user's searches and a user's navigation through content. User history may include, for example, at least one of the user's content purchasing history, content viewing history, content listening history, content download history, content sharing history, content rating history and the like. The content viewing history may include, for example, at least one of viewing of website content, user web queries, video content, digital magazines, digital books, gaming content and the like. In addition, user preferences may also include information obtained from non-content-sources, such as, for example, a user's email history, a user's text messaging, a user's web search and browsing history, and the like.

An indication of the content that a user is interested in receiving more information about or having delivered may be obtained by the digital media content server (120). Either the user device or the server may indicate which of a plurality of social connections may be accessed based on a type of the content available for delivery. For example, a trusted source may be the social connection that is accessed for political-related content, while a user's friend may be accessed for music-related content. A social connection of the user may be accessed to determine a content recommendation based on information obtained by the social connection (130).

The social connections may be those connections that a primary user has with other, secondary, users or trusted sources in a social network. For example, other secondary users may be friends, family, business associates, work colleagues, acquaintances, sports teammates, book club members, and the like. A trusted source may be a blog site, a digital magazine, electronic news agency, a content specific website, a standards organization website, or the like. Primary users as well as other secondary users may have “share” controls that allow the primary and secondary users to specifically set the user's sharing of information. For example, in the instance where the user consents to the use of such data, the data may be used for providing a recommendation related to content. Permission for a user to access the social connection may be confirmed, for example, by the digital media content server or some other device. Information retrieved from the social connection, such as a user's friend or family member may include recommendations of content (which may be written recommendations), ratings, such as an alphanumeric or symbolic ranking, whether the secondary user downloaded particular content, and the like. This information may be used to provide a content recommendation. The content server may process the user preference, user history, content recommendations, and additional information provided by the social connection to calculate a presentation recommendation score specific to the content available for delivery.

In a specific example, the available content on the digital media server may be a pop music band. While preparing to calculate the presentation recommendation, the user's history with respect to the particular pop music band may be accessed based on the user's sharing settings. For example, the user's e-mail may be scanned for e-mails or for particular text relating to the pop music band, or on-line chat history or text messages may also be scanned for messages related to the pop music band. All or some of the text of the e-mails or messages may be scanned for information related to the pop music band. In addition, the user's social connections, such as the user's friends (i.e., a secondary user), may be accessed and scanned for information related to the pop music band. If the secondary user has information, such as a recommendation for a particular song by the pop music band, the server may obtain the recommendation. Information obtained from these connections may be used calculate the presentation recommendation for the pop music band.

The presentation recommendation score based upon the content recommendation provided by the social connection may be generated (140). The presentation recommendation score may be determined using a variety of algorithms. For example, the server may assign a user preference weighting to the content based on user preferences, assign a user history weighting to content based on the user's history related to the content, and assign a social weighting to the content based on social connection recommendations. The server may assign any combination of the above weightings, or may use additional weightings of different data. Using at least one of the user preference weighting, user history weighting, and the social weighting, the server may calculate a presentation recommendation score specific to the content. Of course, other factors and/or weightings may be used.

In response to the presentation recommendation score, a content region definition specific to the content available for delivery may be generated (150). The content region definition may include a presentation dimension, or percentage or other value, for a content region that is sized relative to another content region of a plurality of content regions based upon the content specific presentation recommendation score. The presentation recommendation score may be used to select a content region template that satisfies the presentation dimension. The content region template may specify how the content and any information related to the content may be arranged on a display device.

In addition to the social connections, the presentation recommendation score may also take into account other factors determined by other sources, such as the content provider. For example, content may receive a higher presentation recommendation score because the content provider is offering a discount for the purchase or rental of the particular content in the content category being accessed. Other factors that may influence the presentation recommendation scores may be sponsorship of particular content, media events, such as an awards show or nominations of content for awards, and the like.

Optionally, the content region definition specific to the selected content may be transmitted by the content server (160) to, for example, the user device or another server. The content may also be delivered with the content region definition, delivered prior to the content region definition, or after the delivery of the content region definition. In response to receiving the indication of a selection of content from the delivered content, an updated content region definition may be delivered (170). At the user device, the content may be presented according to the content region definition.

The digital media content server may receive additional indications based on user interactions with the presented content. For example, the digital media device may receive indications that the user has navigated in relation to the delivered content by selecting related content or new and different content. As a result, the server may generate and provide an updated content region definition and content based on the indications related to the user inputs. Alternatively, the server may provide several content region templates based on the content region definition delivered with the content. Although described with respect to a digital media content server, the above described process may be performed locally by for example, a smart phone, a set top box, a desktop, a laptop, a gaming device or similar computing devices. Furthermore, the above process may be performed by a combination of local devices, such as a set top box and smartphone, and remote devices, such as the digital media content server.

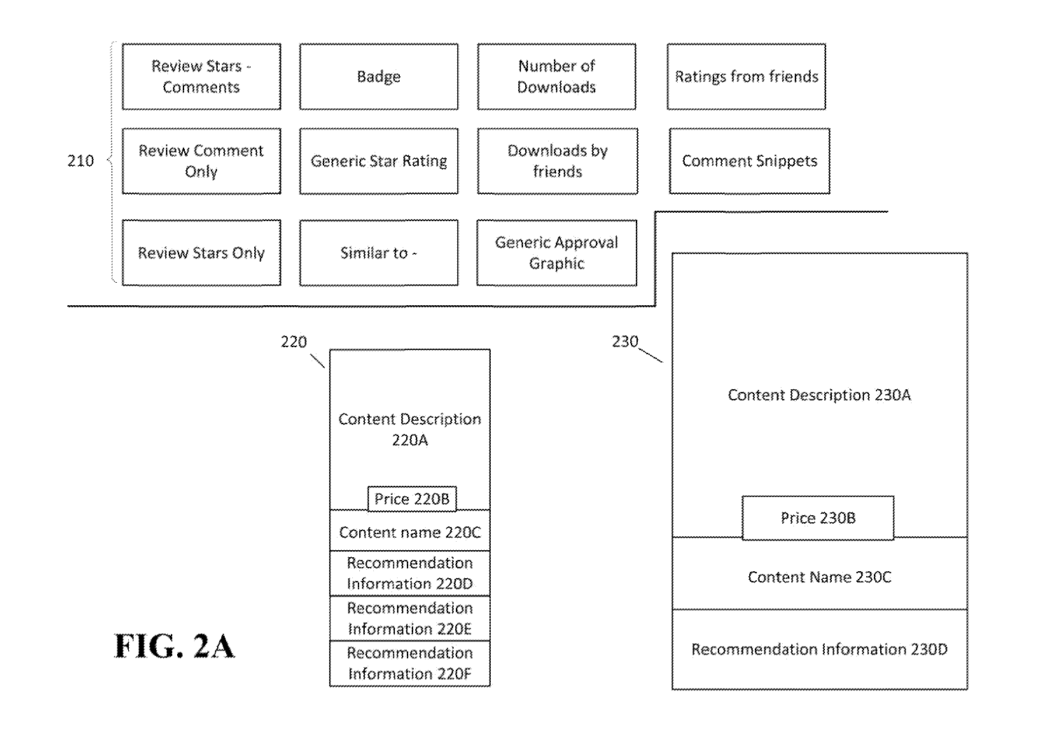

FIG. 2A shows an example illustration of content presentation according to an implementation of the disclosed subject matter. As discussed above, available content may be presented to a user according to a content region definition. The content region definition may indicate the placement and positioning of content cards, such as 220 and 230, for presentation to a user. In addition, the content region definition may include information related to the arrangement of content information within the content cards.

Each content card, such as content cards 220 and 230, may include content information describing or identifying the content and a price of the content. The content cards 220 and 230 may also include additional information, such as information falling into one or more of the recommendation information types 210. The recommendation information types 210 may include information related to, for example, the number of review stars with comments, review comments only, review stars only, a badge, a generic star rating, a generic approval graphic, such as a “like” or “thumbs-up” indicator, a similar to- with a content item that is similar to the presented content, the number of downloads by all users, the number of downloads by friends or others in the user's social connection, ratings from friends, the amount of a video or book that was consumed or read by a user's social connection, links to portions of the content that the user's social connection considered most interesting or uninteresting and the like. Of course, the recommendation information types 210 are not an exhaustive list and other types may be used.

Content cards 220 and 230 may take different forms to meet the available display area of a device. For example, a smartphone may display a content card, such as 220, based on the content definition, while a tablet device may display a content card such as 230. Content having a threshold recommendation score may be determined to be presented on the smartphone. A content card may be configured as shown in card 220. Card 220 may include content information such as the content name, price, and recommendation information that may be presented on the smartphone display. The recommendation information may be information of the type shown by recommendation information types 210. For example, recommendation information may include the number of downloads by friends obtained through the social connection, or the number of overall downloads, which may be obtained from the content provider. In addition,

The content region definition may have different settings for indicating the arrangement of the content information included in the content card. For example, depending on the different settings, content card 220 may include a content description 220A, a content price 220B, a content name 220C, and recommendation information 220C-F. The content description 220A may be an album cover art work, a magazine cover, book cover, an embedded or link to a movie trailer, movie poster art, or any other description of the content. The recommendation information 220C-F may be one or more of the specific recommendation information types 210. In contrast, different settings and a larger display device may allow for a content card to present more or less information, such as content card 230. Content card 230 may be larger, but, in this example, may have less information than content card 220. The content region definition may arrange the content information into clusters of information drawn from, for example, a user's preferences and a content recommendation of the user's social connection. In an implementation, only the user's preferences, only the content recommendation of the user's social connection, or only both are used to define the arrangement of the content information within the content card. The content region definition may indicate the arrangement of the content information in the cluster using a template indicator that is assigned to one of a plurality of templates. The clusters of content information may be arranged according to the template.

FIG. 2B illustrates an example of a content cluster according to an implementation of the disclosed subject matter. In the illustrated example, a cluster of available content 270 may be presented to a user with a title of the content 273 incorporating a number of content cards 275, 277A-C and 279A-D. The cluster title 273 may indicate the type or category of the content, such as pop rock, technology, a specific band name, magazine name, subject matter genre, or the like. The content cards 277A-C and 279A-D incorporate multiple cards in the same dimensions as content card 275. For example, content cards 277A-C may refer to multiple content cards that may include sub-regions 278 having recommendation information.

The content region definition may define region and sub-region, such as sub-regions 278, dimensions for presentation of the content description and the additional information. For example, the presentation dimension may be greater for content with a higher presentation recommendation score than content with a lower presentation recommendation score. As illustrated in FIG. 2B from left to right, content card 275 may have larger dimensions and present a single content card and additional information related to the content, whereas content cards 277A-C and 279A-D may encompass multiple content cards having smaller dimensions than content card 275. Content card 275 may have the larger dimensions due to a higher recommendation score in the respective content category provided by the content server for particular content compared to other content, such as the content shown in cards 277A-C and 279A-D. As a result of the higher recommendation score, content card 275 may have larger presentation dimensions than the other cards 277A-C and 279A-D. Similarly, the content cards encompassed within content card 277A-C may have medium dimensions and have a recommendation score that is considered a medium recommendation score, and the content cards 279A-D may have less content information smaller dimensions and a lower recommendation score than content in both content cards 275 and 277A-C. A template from a plurality of templates may be selected according to the presentation recommendation score that provides the arrangement of content for presentation. In addition, sub-regions containing recommendation information, such as 278, within the individual content cards 277A-C may also be based on the presentation recommendation scores for the content of content cards 277A-C. The content region definition may include the template for presenting content and information related to the content.

In an implementation, a user device may provide to the content server an indication of at least one of the device type, device capabilities and device specifications, such as processor type, display screen dimensions and the like. This indication may be included with, or in addition to, user preferences and user history obtained by the digital media server. Based on the provided capabilities and specification, a template may be selected based on a screen width and height of a device to which the content is being delivered. For example, the content region definition may include a template for presenting content and information related to the arrangement of content based on the at least one of a particular device type, device capabilities and device specifications. The content region definition may further indicate how content may be arranged within the regions and sub-regions of the template in addition to how the content may be arranged when the display is in either portrait or landscape mode.

With reference to FIG. 2B, the cluster of content 270 may be provided, for example, for a tablet or laptop computing device. The content server may deliver a number of templates with the content, after or prior to the content being provided. The specific content with a higher recommendation score may entail not only dedicating more area of the display device real estate to the higher preference scored content, but may also incorporate more information related to the content. The additional display real estate may be used to provide other in sub-regions that may include additional recommendation information, such as snippets related to, for example, the content author or artist, a review or recommendation from a secondary user or trusted source, the number of downloads of the content (which may be an indication of popularity) by all users, the number of downloads by secondary users related to the primary user, the number of other secondary users that have purchased or recommended the content, reviews written by the secondary users or the like. For example, in FIG. 2B, content card 275 may have snippets related to the content, such as the content name, badge, review starts-comments, or number of downloads by the user's friends. Similarly, the three content cards 277A-C may include additional information 278 that provides snippets related to the content. The additional information 278 may be arranged in sub-regions that are related to the respective content. The additional information 278 may not be as extensive as that provided for the content presented in content card 275 because the content cards 277A-C may have a lower presentation score than the content of content card 275.

The cluster arrangement may change according to the presentation recommendation scoring. For example, with reference to FIGS. 2A and 2B, the arrangement of the recommendation information in the sub-regions of the respective content cards may change within the respective template based on the recommendation scores. For example, the content card 275 may be presented because the content shown in it may have the highest presentation score. The arrangement of the recommendation information presented in content cards 279A-D may be different than the recommendation information provided in content cards 277A-C due to a lower recommendation score.

The content region definition may include region and sub-region dimensions that maintain the percentage of screen display for presented content in both a portrait and landscape presentation orientation. For example, the template may be configured to optimize the presentation of content on a tablet, smartphone, desktop, laptop, television or the like, and also take into account the display orientation, such as portrait or landscape. In general, the plurality of templates may be generated to organize the content based on preference scores, so that a user may make a more informed and quicker decision related to the content, such as purchasing, renting, or investigating further.

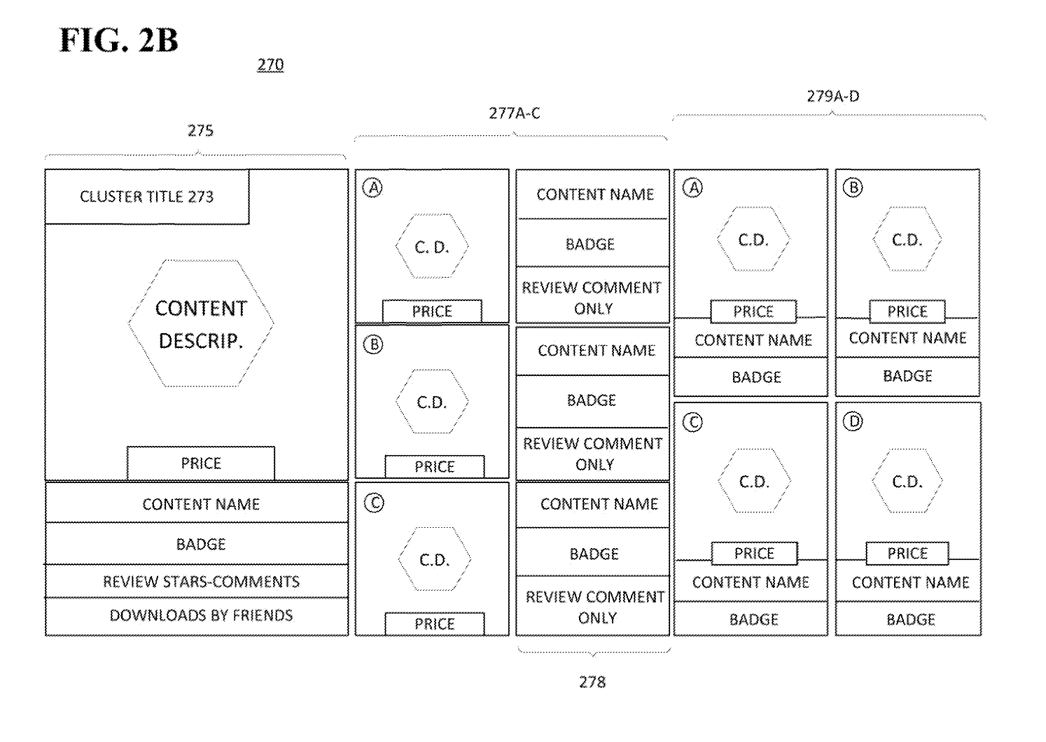

Embodiments of the presently disclosed subject matter may be implemented in and used with a variety of component and network architectures. FIG. 3 is an example of a computing device 20 suitable for implementing implementations of the presently disclosed subject matter. The computing device 20 includes a bus 21 which interconnects major components of the computing device 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computing device 20 are generally stored on and accessed via a computer readable medium, such as a hard disk drive (e.g., fixed storage 23), an optical drive, floppy disk, or other storage medium 25.

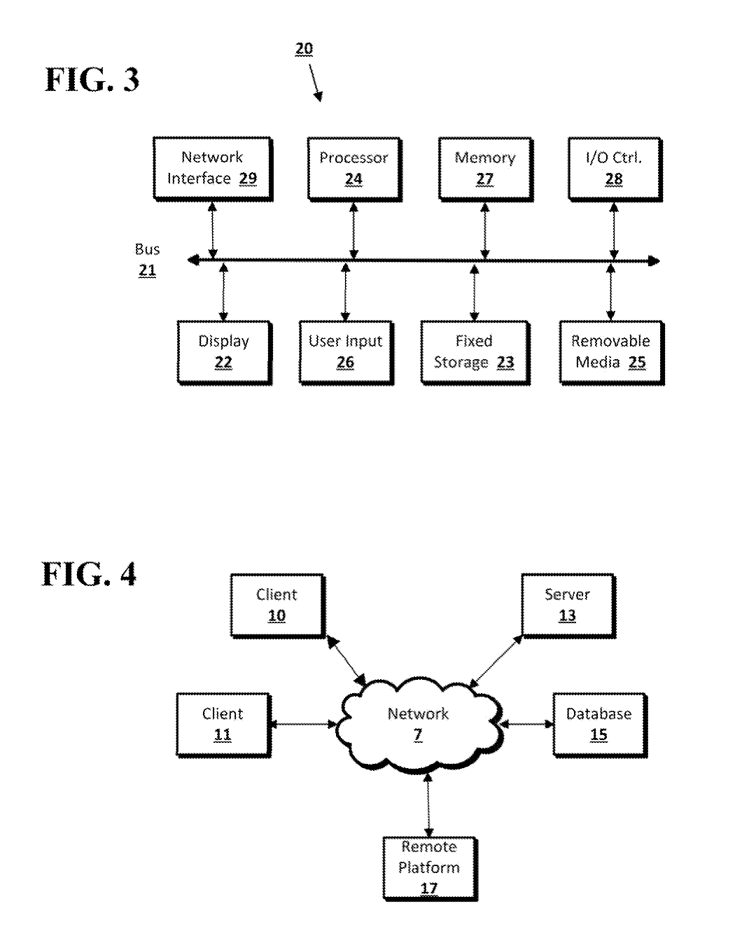

The fixed storage 23 may be integral with the computing device 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computing device such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an implementation of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. The one or more servers 13 or remote platform 17 may function as the digital media content server. One or more of servers 13 or remote platform 17 may also have access to the above-described user social connections, user history and user preferences. Furthermore, one or more of servers 13 or remote platform 17 may verify or authenticate the user's access to the social connections and may verify the user's (both primary and secondary) sharing settings

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

More generally, various implementations of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
identifying, at a digital media content server, a user presence;
obtaining an indication of content available for delivery;
accessing a social connection of the user to determine a content recommendation provided by the social connection;
generating a presentation recommendation score based upon the content recommendation provided by the social content;
in response to the presentation recommendation score, generating a content region definition specific to the content available for delivery, wherein the content region definition includes a presentation value.

2. The method of claim 1, wherein the presentation value is a dimension for a content region that is sized relative to another content region of a plurality of content regions based upon the content specific presentation recommendation score.

3. The method of claim 1, further comprising:
obtaining a user preference and user history related to content available for delivery by the digital media content server.

4. The method of claim 1, wherein the presentation recommendation score is generated by calculating a score based on a user preference, a user history and the content recommendation provided by the social connection.

5. The method of claim 4, wherein the calculating further comprises:
assigning a user preference weighting to content based on user preferences;
assigning a user history weighting to content based on user history related to content;
assigning a social weighting to content based on social recommendations; and
calculating a presentation recommendation score specific to the content based on the user preference weighting, user history weighting, and the social weighting.

6. The method of claim 1, further comprising:
in response to a selection of content from the content available for delivery, providing the selected content and a content region definition specific to the selected content.

7. The method of claim 1, wherein the content region definition is provided prior to receiving an indication of selection of content.

8. The method of claim 1, wherein the obtaining the user preferences and user history comprises:
receiving the user's preferences and user history from a portable device associated with the user.

9. The method of claim 8, wherein the user history includes at least one of the user's content purchasing history, content viewing history, content listening history, content download history, content sharing history, and content rating history.

10. The method of claim 9, wherein content viewing history includes at least one of viewing of website content, user web queries, video content, digital magazines, digital books and gaming content.

11. The method of claim 1, further comprising:
providing an updated content region definition and content based on inputs related to the delivered content.

12. The method of claim 1, wherein the social connection is a trusted source of content, and the content recommendation is a review from the trusted source of the content of interest.

13. The method of claim 1, wherein the social connection is an individual, and the content recommendation is an indicator of the individual's satisfaction with the content.

14. The method of claim 1, wherein the content region definition identifies a percentage of screen space that the particular content is to cover on a user display device.

15. The method of claim 1, wherein the content region definition indicates an arrangement of content-related information into clusters of information drawn from a user's preferences and a content recommendation of the user's social connection.

16. The method of claim 15, wherein information in the cluster is arranged according to a template.

17. The method of claim 15, wherein the content is arranged into content collections, wherein a content collection is a category of content.

18. The method of claim 1, wherein the presentation dimension is greater for content with a higher presentation recommendation score than content with a lower presentation recommendation score.

19. The method of claim 1, wherein user history relates to purchases and is adaptively based on user searches, and user navigation through content.

20. The method of claim 1, wherein the accessing a social connection comprises:
determining which of a plurality of social connections to access based on a type of the content available for delivery.

21. The method of claim 1, further comprising:
selecting a template from a plurality of templates according to the presentation recommendation score, wherein the content region definition includes the template for presenting content and information related to the content.

22. The method of claim 1, further comprising:
selecting a template based on a screen width and height of a device to which the content is being delivered, wherein the content region definition includes the template for presenting content and information related to the content.

23. The method of claim 1, wherein the content region definition includes a sub-region.
